(19) United States
(12) Patent Application Publication
(10) Pub. No.: US 2007/0068764 A1
(43) Pub. Date: Mar. 29, 2007

(54) Adapter for sprag clutch

(76) Inventor: Gary W. Charbonneau, Milford, MI (US)

Correspondence Address: THE WEINTRAUB GROUP, P.L.C., Suite 240, 32000 Northwestern Highway, Farmington Hills, MI, 48334, US

(21) Appl. No.: 11/528,921

(22) Filed: Sep. 28, 2006

Related U.S. Application Data
(60) Provisional application No. 60/721,242, filed on Sep. 28, 2005.

(51) Int. Cl. F16D 13/68

(52) U.S. Cl. 192/115

(57) ABSTRACT

an adapter assembly for converting a sprag clutch assembly in a recent but discontinued transmission into a sprag clutch assembly found in older transmissions thereby reengineering and upgrading the discontinued transmission for use with an older system.

### CROSS-REFERENCE TO RELATED APPLICATION

This is a completion application of co-pending U.S. Provisional Patent Application Ser. No. 60/721,242, filed Sep. 28, 2005, the entire disclosure of which is incorporated herein by reference.

### BACKGROUND OF THE INVENTION

1. Field of the Invention

The present invention pertains to automobile transmissions and more particularly to an adapter assembly for converting a sprag clutch assembly in a recent but discontinued transmission into a sprag clutch assembly found in older transmissions thereby reengineering and upgrading the discontinued transmission for use with an older system.

2. Description of the Prior Art

Many transmissions are known, such as the E40D and 4R100 model used in many four speed, rear wheel drive vehicles Ford manufactured between 1986 and 1996. Illustrative are the following automobiles and trucks: the Bronco, the Econoline models 150, 250, and 350, the Excursion, the Expedition, and the truck models F-150, 250, 350 and 450.

Thereafter, and between 1995 and 2004, the transmission was modified as regards an intermediate sprag clutch that is mounted about a clutch drum. In particular, a cylindrical sleeve of the drum was changed to include gear teeth about the sleeve. Ultimately, the transmission design was discontinued in favor of the original design.

During the period of manufacture of the above vehicles, between 1995 and 2004, some 500,000 vehicles may have been produced. However, because of the modification, parts are now essentially available only for the original design. Owners who need to repair the discontinued transmission would desire an inexpensive alternative to buying a new transmission.

A primary object of this invention is the provision of an adapter for converting the intermediate drum of a discontinued transmission and sprag clutch associated with the drum, thereby reengineering the discontinued clutch assembly into a formerly provided transmission.

A further object is the provision of an adapter kit for sale in the aftermarket whereby an owner of a vehicle equipped with a discontinued transmission may convert the transmission into one that is in conformance with currently sold transmissions.

### SUMMARY OF THE INVENTION

The present invention discloses an adapter for converting the intermediate drum of a transmission, the drum including an annular end face and a cylindrical sleeve provided with an array of gear teeth arranged around the exterior surface thereof, the adapter comprising
a thin flat planar annular washer configured for fitment about the sleeve, the washer having a lower surface adapted to be abutted against the annular end face of said drum and an upper surface,
a hat shaped adapter member, including a cylindrical adapter sleeve having an inner wall adapted for sliding fitment over and about the drum sleeve and an annular end wall adapted for compressing engagement against the upper surface of the washer, the inner wall provided with at least one tooth dimensioned for interlocking engagement with an adjacent pair of gear teeth, and
means for interlocking the washer relative to the adapter member.

According to this embodiment of the invention, the means for interlocking comprises a complementary plurality of radially outwardly and inwardly directed tabs and tab receivers, respectively, operating between the washer and the annular end wall of the adapter sleeve, the tabs fitting within the tab receivers to interlock the washer and adapter with one another and inhibit relative rotation therebetween.

Further and according to this embodiment of the invention, a like number of complementary gear teeth are arranged around and project radially inwardly from the inner wall of the adapter sleeve for meshed interengagement with respective of the gear teeth of said transmission drum.

Preferably, the adapter includes an arrangement for passing lubricating oil inwardly to the drum when the adapter is fitted about the drum, including at least one passage extending radially through the cylindrical wall of the adapter sleeve and at least one groove on the upper surface of said washer, the groove extending radially between the inner and outer circumferences of the washer.

Also and according to an aspect of this invention, there is provided a kit for converting a transmission of the type including a sprag clutch mountable about a drum having gear teeth around the exterior thereof, the kit comprising
a thin flat annular washer, the washer being fittable about the drum and against an annular end face thereof and having a plurality of tabs extending radially outwardly from the outer circumference thereof,
a stepped cylindrical hat shaped adapter, the adapter comprising a cylindrical adapter sleeve dimensioned to fit about the drum and provided with internal gear teeth sized to mesh with the drum teeth, and an annular end wall at one end of the adapter sleeve, the annular end wall having forward and rearward surfaces with the forward surface being adapted to compress against the washer and provided with a plurality of sockets extending radially inwardly from the outer circumference of the washer to interlock within a respective of the sockets, and
a sprag clutch, the clutch being toroidal in shape and including inner and outer surfaces disposed concentrically, forward and rearward end faces, and a plurality of sprags disposed 360° therearound, the sprags being disposed radially and having respective end portions extending, at least in part, into the interior of the torus and adapted to engage the outer surface of the adapter sleeve.

The present invention will be more clearly understood with reference to the accompanying drawings and to the following Detailed Description, in which like reference numerals refer to like parts and where:

### BRIEF DESCRIPTION OF THE DRAWINGS

FIG. 1 is a perspective view of a pertinent parts of a prior art transmission including an intermediate sprag clutch and drum assembly thereof

FIG. 2 is a perspective view of a discontinued prior art transmission with adapter parts, according to this invention, positioned for assembly to a modified drum of the intermediate sprag assembly thereof wherein to convert this discontinued transmission into an assembly that corresponds to the assembly of FIG. 1.

FIGS. 3 and 4 are plan and elevation section views of an adapter according to this invention.

FIGS. 5, 6 and 6A are plan, elevation, and section views of a washer according to this invention.

### DETAILED DESCRIPTION OF THE PREFERED EMBODIMENT

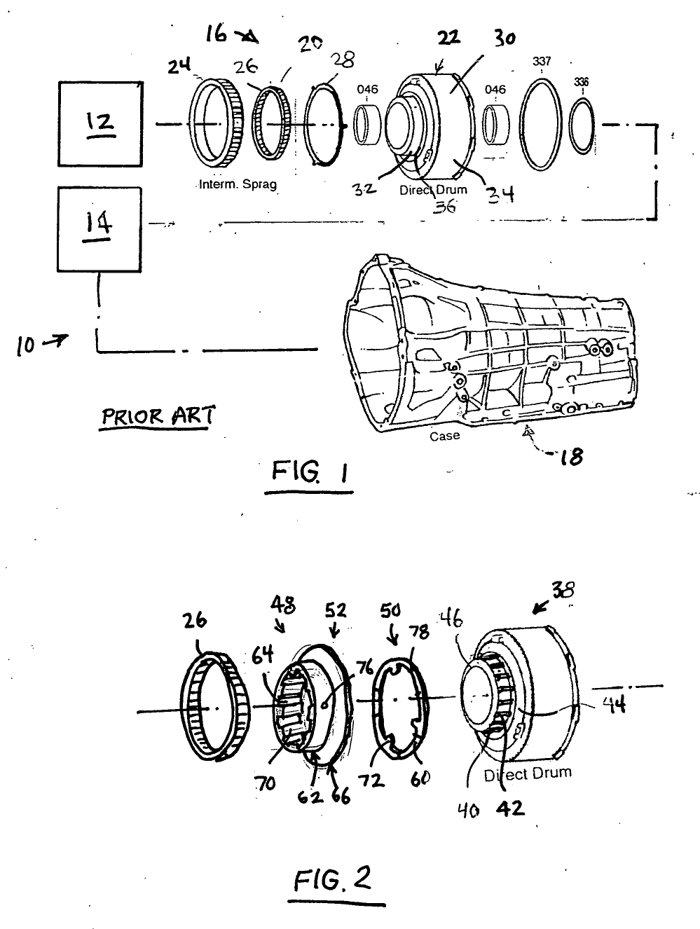

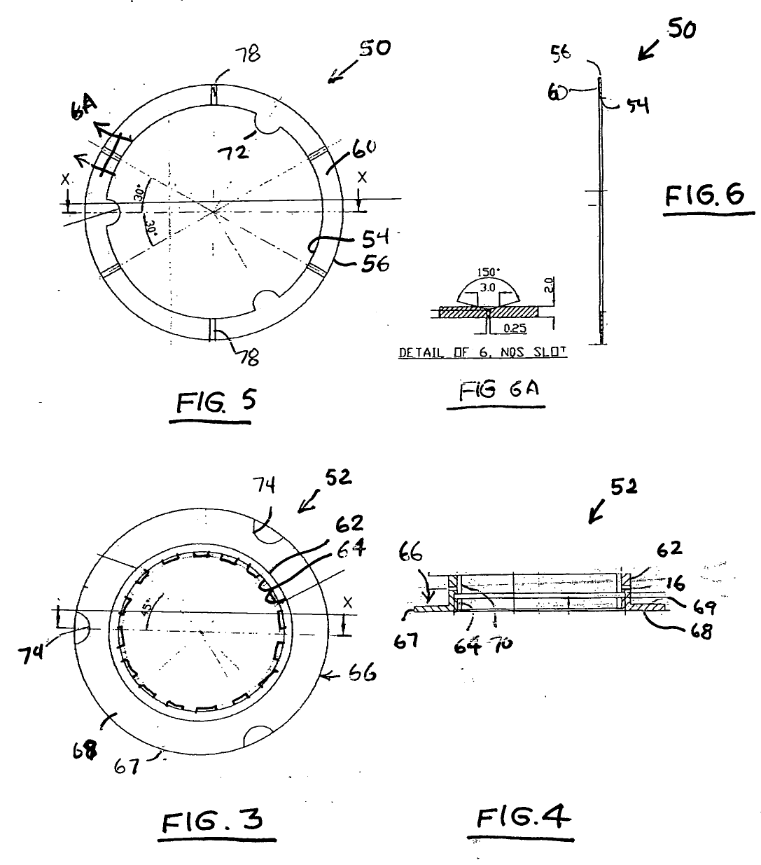

Turning now to the drawings, FIG. 1 is a perspective view of a pertinent parts of a Ford Model E40D and 4R100 transmissions, which was used in two different time periods, including the present. The transmission is indicated at 10 and includes forward and rearward portions 12 and 14, an intermediate portion 16 and a case 18 into which the portions are fitted. The intermediate portion 16 comprises an intermediate sprag clutch assembly 20 and a drum assembly 22 upon which the clutch assembly is fitted. The portions 12 and 14 are conventional and will not be described further.

The intermediate portion 16, in pertinent part, forms a sprag clutch assembly that includes a toothed gear wheel 24, a sprag clutch 26, and a washer 28.

The drum assembly 22, in pertinent part, comprises a direct drum 30, which includes cylindrical forward and rearward end portions 32 and 34 disposed concentrically, and an annular end wall 36 extending between the end portions 32 and 34.

In application, the sprag clutch assembly 16 is fitted about the forward end portion 32 and abutted against the annular end wall 36.

FIG. 2 is a perspective view, in pertinent part, of a second and discontinued prior art transmission, which is also designated as the E40D and 4R100 transmission. Although not shown, this second transmission includes the portions 12 and 14 and the case 18, as noted above.

However, the drum assembly, shown at 38, is similar to the drum assembly 22, but is modified in that the forward end portion 40 is of reduced diameter and includes an array of gear teeth 42 disposed 360° therearound. The gear teeth 42 are arranged generally equiangulary and extend between the annular end wall 44 thereof and towards the forward end face 46 of the sleeve portion 40.

According to this invention, an adapter assembly 48, in combination with the toothed gear wheel 24 and sprag clutch 26, are positionable over and about the forward end portion 40. The adapter assembly 48 includes an annular washer 50 and a hat-shaped adapter member 52, the adapter parts 50 and 52 configured to convert this discontinued transmission into the transmission assembly 10, and described in connection with FIG. 1.

The washer 50 comprises a thin flat planar sheet of pliable material having an inner circumference 54 dimensioned for fitment about the forward end portion 40, and outer circumference 56, a lower or first surface 58 adapted to be abutted against the annular end wall 44 of the drum 38, and an upper or second surface 60. While many materials are suitable, an oil resistant polymeric material is desirable.

The adapter member 52 includes a cylindrical adapter sleeve 62 having an inner wall 64 adapted for sliding fitment over and about the forward end portion 40 of the drum sleeve 38 and an annular end wall 66 having a generally planar surface 68 adapted for compressing engagement against the upper surface 60 of the washer 50, and an upper surface 69. The inner wall 64 of the sleeve 62 is provided with at least one tooth, and preferably a like number of gear teeth 70, spaced equiangularly 360° therearound, and dimensioned for interlocking engagement with the gear teeth 44 on the forward end portion 40 of the drum 38.

Preferably, structure is provided for interlocking the washer 50 relative to the adapter member 52.

According to this invention, the means for interlocking comprises a complementary plurality of radially and inwardly directed tabs 72 and tab receivers 74, respectively, operating between the washer 50 and the annular end wall 66 of the adapter sleeve 62. In the embodiment illustrated, the tab receivers 74 are recesses formed in the surface 68 of the end wall 66 and extend radially inwardly from the outer circumference 67 thereof. The tabs 72 extend radially inwardly from the inner circumference 54 of the washer 50 and fit within a respective of the tab receivers 74 wherein to interlock the washer and adapter with one another and inhibit relative rotation therebetween.

Preferably, the adapter member 52 includes an arrangement for passing lubricating oil inwardly to the drum 38 when the adapter member is fitted about the drum. In the embodiment illustrated, at least one and preferably three passages 76 extend radially through the cylindrical wall of the forward end portion 40 of the adapter sleeve 52. Further, at least one and preferably six grooves 78 are provided on the upper surface 60 of the washer, the groove(s) 78 extending radially between the inner and outer circumferences 54 and 56 of the washer. Preferably, the grooves 78 and passages 76 are equiangularly spaced.

Also and according to an aspect of this invention, there is provided a kit for converting a transmission of the type including a sprag clutch mountable about a drum having gear teeth around the exterior thereof. According to this invention, the kit comprises the annular washer 50, the stepped cylindrical hat-shaped adapter member 52, and a sprag clutch 26.

The sprag clutch 26 is toroidal in shape and includes inner and outer surfaces disposed concentrically, forward and rearward end faces, and a plurality of sprags disposed 360° therearound. The sprags are disposed radially and respective end portions extend, at least in part, into the interior of the torus and are adapted to engage the outer surface of the adapter sleeve 52.

Although a particular embodiment of the invention has been described in detail for purposes of illustration, various modifications may be made without departing from the spirit and scope of the invention. Accordingly, the invention is not to be limited, except by the appended claims.

What I claim is:

1. An adapter for converting the intermediate drum of a transmission, the drum including an annular end face and a cylindrical sleeve provided with an array of gear teeth arranged around the exterior surface thereof, the adapter comprising
a thin flat planar annular washer configured for fitment about the sleeve, the washer having a lower surface adapted to be abutted against the annular end face of said drum and an upper surface,
a hat shaped adapter member, including a cylindrical adapter sleeve having an inner wall adapted for sliding fitment over and about the drum sleeve and an annular end wall adapted for compressing engagement against the upper surface of the washer, the inner wall provided with at least one tooth dimensioned for interlocking engagement with an adjacent pair of gear teeth, and
means for interlocking the washer relative to the adapter member.

2. The adapter according to claim 1, wherein the means for interlocking comprises a complementary plurality of radially outwardly and inwardly directed tabs and tab receivers, respectively, operating between the washer and the annular end wall of the adapter sleeve, the tabs fitting within the tab receivers to interlock the washer and adapter with one another and inhibit relative rotation therebetween.

3. The adapter according to claim 1, wherein a like number of complementary gear teeth are arranged around and project radially inwardly from the inner wall of the adapter sleeve for meshed interengagement with respective of the gear teeth of said transmission drum.

4. The adapter according to claim 1, further comprising an arrangement for passing lubricating oil inwardly to the drum when the adapter is fitted about the drum, the arrangement including at least one passage extending radially through the cylindrical wall of the adapter sleeve and at least one groove on the upper surface of said washer, the groove extending radially between the inner and outer circumferences of the washer.

5. A kit for converting a transmission of the type including a sprag clutch mountable about a drum having gear teeth around the exterior thereof, the kit comprising
a thin flat annular washer, the washer being fittable about the drum and against an annular end face thereof and having a plurality of tabs extending radially outwardly from the outer circumference thereof,
a stepped cylindrical hat shaped adapter, the adapter comprising a cylindrical adapter sleeve dimensioned to fit about the drum and provided with internal gear teeth sized to mesh with the drum teeth, and an annular end wall at one end of the adapter sleeve, the annular end wall having forward and rearward surfaces with the forward surface being adapted to compress against the washer and provided with a plurality of sockets extending radially inwardly from the outer circumference of the washer to interlock within a respective of the sockets, and
a sprag clutch, the clutch being toroidal in shape and including inner and outer surfaces disposed concentrically, forward and rearward end faces, and a plurality of sprags disposed 360° therearound, the sprags being disposed radially and having respective end portions extending, at least in part, into the interior of the torus and adapted to engage the outer surface of the adapter sleeve.
